(19) United States
(12) Patent Application Publication
(10) Pub. No.: US 2023/0398558 A1
(43) Pub. Date: Dec. 14, 2023

(54) SHOWER HEAD WITH ROTARY JET WATER

(71) Applicant: Xiamen Delmei Sanitary Ware Co., Ltd., Xiamen (CN)

(72) Inventors: Lengjie HUANG, Anxi (CN); Chunhua WANG, Xiamen (CN); Changzheng NI, Xiamen (CN); Yongqiang YAN, Fuzhou (CN)

(21) Appl. No.: 18/209,431

(22) Filed: Jun. 13, 2023

(30) Foreign Application Priority Data
Jun. 13, 2022 (CN) 202221469387.1

(51) Int. Cl. B05B 3/04; B05B 1/18

(52) U.S. Cl. CPC B05B 3/04; B05B 1/18

(57) ABSTRACT

The present disclosure relates to the field of bathroom products and in particular to a shower head with rotary jet water, including a shower head body, where the shower head body is provided with a water distribution mechanism and a plurality of first water outlet holes, and the water distribution mechanism is used to control a water delivery state of the first water outlet hole; a water partition disk and a plurality of rotary mechanisms are fixedly disposed in the shower head body, a plurality of pressurizing mechanisms are disposed on the water partition disk, the pressurizing mechanism includes a plurality of water guide holes annularly arranged, a flow guide surface inclined toward the first water outlet hole is disposed inside the water guide hole, and the inclination direction of the flow guide surfaces of each pressurizing mechanism is co-directionally disposed in a circumferential direction.

### CROSS-REFERENCE TO RELATED APPLICATION

This application claims priority from the Chinese patent application 202221469387.1 filed Jun. 13, 2022, the content of which is incorporated herein in the entirety by reference.

### TECHNICAL FIELD

The present disclosure relates to the field of bathroom product technologies, and in particular to a shower head with rotary jet water.

### BACKGROUND

Shower head or sprinkler refers to a water spraying head used in a shower. Along with increasing quality of life, users have increasing requirements for functionality and comfort of water delivery in addition to external appearance. Typically, shower heads have different shapes in a variety of styles and therefore, shower heads with a single jet of water do not meet shower requirements of users. In order to meet such requirements, shower heads having multiple water delivery effects have been developed, which can change water stream size, the number of streams, and the like.

However, in the prior art, although different water delivery modes can be achieved by switching a water passage and changing a water pressure to change the water stream size and water delivery position, they are still simple water streams. Therefore, users cannot enjoy different use experiences. Further, water flow and mode switching are relatively fixed, resulting in poor user experience.

### SUMMARY

The present disclosure aims to provide a shower head capable of spraying water in a rotary manner and delivering a large and stable water flow, so as to solve the aforementioned problems of the prior art.

In order to achieve the above purposes, the present disclosure provides the following technical solution: provided is a shower head with rotary jet water, including a shower head body. The shower head body is provided with a water distribution mechanism and a plurality of first water outlet holes, and the water distribution mechanism is used to control a water delivery state of different first water outlet holes.

A water partition disk and a plurality of rotary mechanisms are fixedly disposed in the shower head body. A plurality of pressurizing mechanisms are disposed on the water partition disk and the pressurizing mechanism includes a plurality of water guide holes annularly arranged. A flow guide surface inclined toward the first water outlet hole is disposed inside the water guide hole. The inclination direction of the flow guide surfaces of each pressurizing mechanism is co-directionally disposed in a circumferential direction.

The rotary mechanism includes a rotor and a drive gear in transmission connection with the rotor. The rotor is disposed below the pressuring mechanism, a rotary shaft corresponding to the first water outlet hole is disposed on the drive gear, and the rotary shaft is rotatably mounted in the first water outlet hole and axially provided with an outlet water passage with two ends in communication.

Furthermore, a pinion is coaxially disposed on the rotor and the pinion is in engagement transmission with the drive gear.

Furthermore, the rotary mechanism further includes a water partition piece embedded in an end of the outlet water passage away from the first water outlet hole, and a plurality of small holes are uniformly disposed on the water partition piece.

Furthermore, the outlet water passage includes a flow guide portion, a water outlet and a flow expanding portion sequentially connected. The water outlet has a cross sectional area smaller than a cross sectional area of the flow guide portion, and the flow expanding portion is horn-shaped.

Furthermore, the water distribution mechanism includes a water distribution disk and a knob fixedly connected. The knob is rotatably connected at an outer side of the shower head body, and the water distribution disk is disposed between the water partition disk and the first water outlet hole. A first water inlet hole is disposed on the water distribution disk. A plurality of mutually-independent first water passages and second water passages are disposed on the water partition disk. The first water inlet hole communicates with different first water outlet holes respectively through the first water passages and the second water passages.

Furthermore, a first panel is disposed in the shower head body. The first panel is disposed between the water distribution disk and the water partition disk. A plurality of second water inlet holes in respective communication with the first water passages and the second water passages are disposed on the first panel. When the first water inlet hole is in communication with the second water inlet hole, the corresponding first water passage or second water passage is opened.

Furthermore, a second panel is disposed in the shower head body. The second panel is disposed at a side of the water partition disk close to the first water outlet hole. A vertical wall corresponding to the water partition disk and a second water outlet hole corresponding to the first water outlet hole are disposed on the second panel. The vertical wall and the water partition disk cooperate to form an inlet water chamber for mounting the rotary mechanism. The second water outlet hole located inside the vertical wall is in communication with the first water passage, and the second water outlet hole outside the vertical wall is in communication with the second water passage. The pressurizing mechanism is disposed inside the first water passage.

Furthermore, the first water outlet holes are disposed to have several groups of different hole sizes.

Compared with the prior art, the present disclosure has the following beneficial effects.

In the present disclosure, a water partition disk and a rotary mechanism are disposed in the shower head body, a plurality of water guide holes annularly arranged are disposed on the water partition disk and a flow guide surface inclined clockwise is disposed inside the water guide hole. In this case, when water flows through the flow guide surface, a small vortex flow is formed, thus increasing water pressure and improving water flow dynamics. The rotary mechanism is disposed below the water guide hole and includes a rotor and a drive gear in mutual transmission cooperation, a rotary shaft is disposed on the drive gear and rotatably mounted in the first water outlet hole, and an outlet water passage is disposed in the rotary shaft. In use, the formed small vortex flow generates a rotary power to drive the rotor to start rotating which in turn drives the drive gear to rotate. Thus, the water flow has rotary power when coming out of the outlet water passage, so as to form a rotary jet of water, resulting in different shower experiences and improving feeling during use.

### BRIEF DESCRIPTIONS OF THE DRAWINGS

In order to more clearly describe the technical solution of the embodiments of the present disclosure, the accompanying drawing required for descriptions of the embodiments will be briefly introduced below. It should be understood that the drawings below are only used to show some embodiments of the present disclosure, and thus shall not be considered as limiting of the scope of protection of the present disclosure. Other drawings may be obtained by those skilled in the art based on these drawings without making creative work.

FIG. 1 is an exploded view illustrating a structure of an embodiment of the present disclosure.

FIG. 2 is a sectional view illustrating a structure of an embodiment of the present disclosure.

FIG. 3 is a structural schematic diagram illustrating a rotary mechanism according to an embodiment of the present disclosure.

FIG. 4 is an exploded view illustrating a structure of a rotary mechanism according to an embodiment of the present disclosure.

FIG. 5 is a mounting diagram illustrating a rotary mechanism and a water partition disk according to an embodiment of the present disclosure.

FIG. 6 is a structural schematic diagram illustrating a water partition disk according to an embodiment of the present disclosure.

FIG. 7 is a structural schematic diagram illustrating a first panel according to an embodiment of the present disclosure.

FIG. 8 is a structural schematic diagram illustrating a second panel according to an embodiment of the present disclosure.

FIG. 9 is a schematic diagram illustrating an entire structure according to an embodiment of the present disclosure.

FIG. 10 is a schematic diagram illustrating a structure according to a second embodiment of the present disclosure.

FIG. 11 is a schematic diagram illustrating a perspective view of a structure according to a second embodiment of the present disclosure.

FIG. 12 is a schematic diagram illustrating a rear perspective view of a structure according to a second embodiment of the present disclosure.

FIG. 13 is a schematic diagram illustrating a structure according to a third embodiment of the present disclosure.

FIG. 14 is a schematic diagram illustrating a perspective view of a structure according to a third embodiment of the present disclosure.

FIG. 15 is a schematic diagram illustrating a rear perspective view of a structure according to a third embodiment of the present disclosure.

### NUMERALS OF THE DRAWINGS ARE DESCRIBED BELOW

1. Shower head body;
11. Upper cover, 12. Lower cover, 13. First water outlet hole;
2. Water partition disk;
21. Pressurizing mechanism, 22. First water passage, 23. Second water passage, 211. Water guide hole, 213. Flow guide surface;
3. Rotary mechanism;
31. Rotor, 32. Drive gear, 33. Rotary shaft, 34. Pinion, 35. Water partition piece, 331. Outlet water passage, 351. Small hole, 3311. Flow guide portion, 3312. Water outlet, 3313. Flow expanding portion;
4. Water distribution mechanism;
41. Water distribution disk, 42. Knob, 411. First water inlet hole;
5. First panel;
6. Second panel;
61. Vertical wall, 62. Second water outlet hole.
800. Second embodiment of shower head body; 801. Third water outlet hole; 802. Fourth water outlet hole; 803. Second water inlet hole.
900. Third embodiment of shower head body; 901. Fifth water outlet hole; 902. Sixth water outlet hole; 903. Seventh water outlet hole; 904. Eighth water outlet hole; 905. Third water inlet hole.

### DETAILED DESCRIPTIONS OF EMBODIMENTS

In order make the objects, technical solutions and advantages of the embodiments of the present disclosure clearer, the technical solutions of the embodiments of the present disclosure will be fully and clearly described in combination with the drawings in the embodiments of the present disclosure. Apparently, the embodiments described herein are merely some embodiments of the present disclosure rather than all embodiments. All other embodiments obtained by those skilled in the art based on the embodiments of the present disclosure without making creative work shall fall within the scope of protection of the present disclosure. Therefore, the subsequent detailed descriptions of the embodiments of the present disclosure provided by the accompanying drawings are not intended to limit the claimed scope of protection of the present disclosure but only represent some selected embodiments of the present disclosure. All other embodiments obtained by those skilled in the art based on the embodiments of the present disclosure without making creative work shall fall within the scope of protection of the present disclosure.

In the descriptions of the present disclosure, the terms “first” and “second” are used only for descriptions and shall not be understood as indicating or implying any relative importance or implicitly indicating a number of the indicated technical features. Therefore, the features limited by “first” and “second” may explicitly or implicitly include one or more of the features. In the descriptions of the present disclosure, “plurality” has two or more meanings unless otherwise defined specifically.

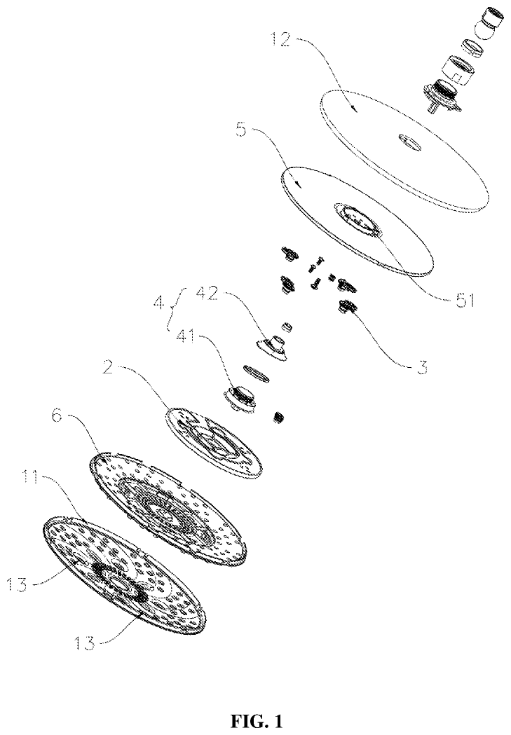

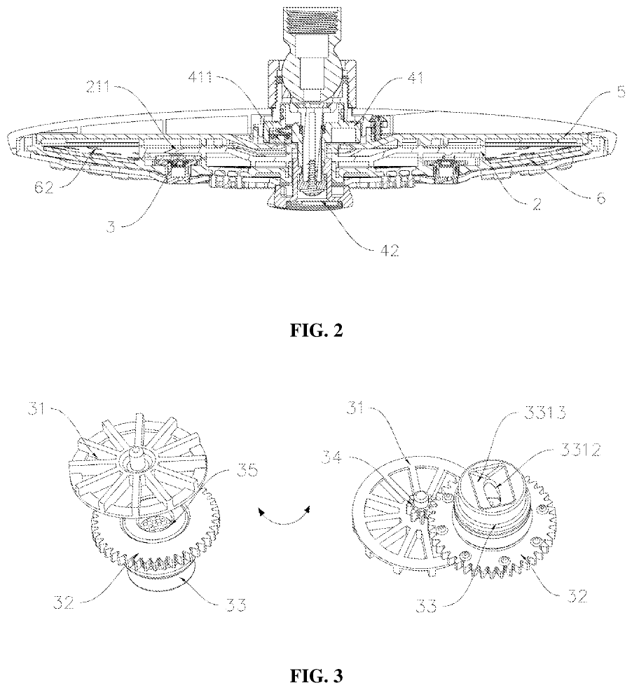

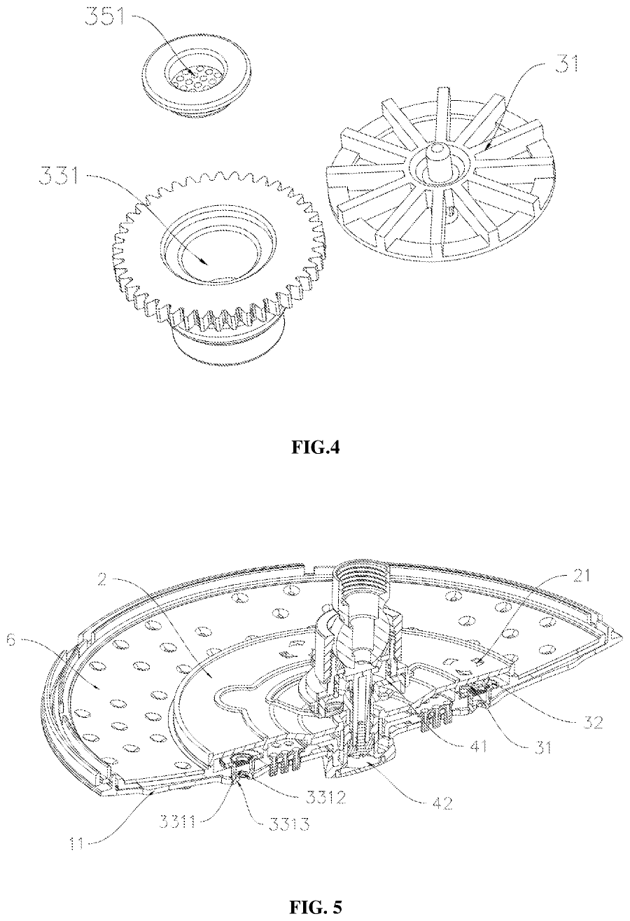

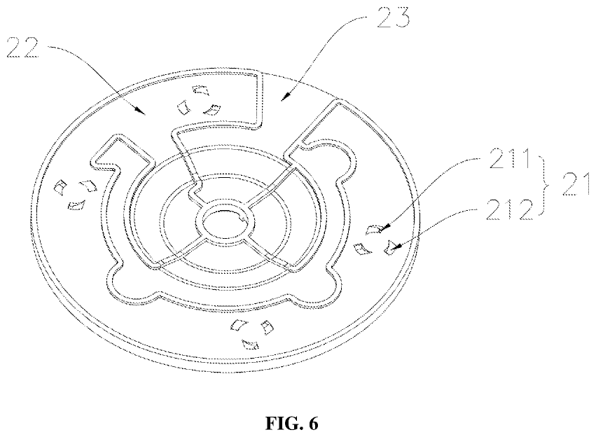

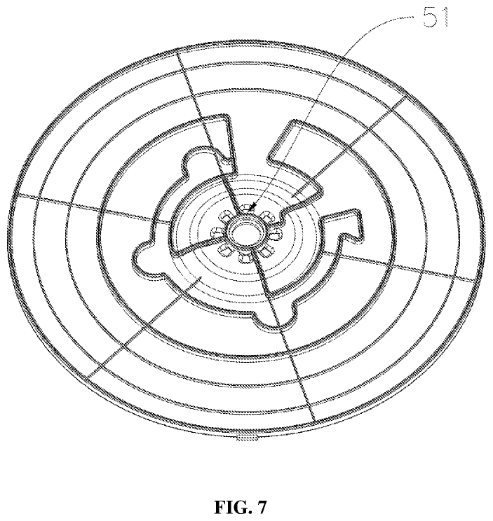

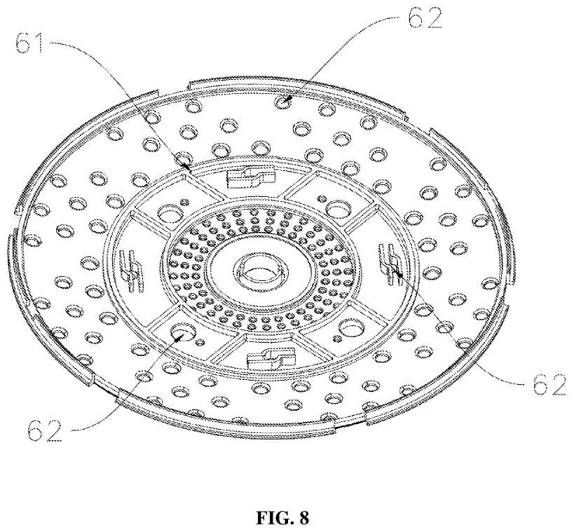

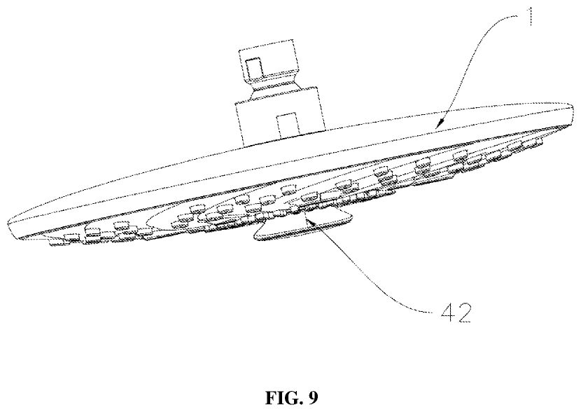

As shown in FIGS. 1 to 9, provided is a shower head with rotary jet water, including a shower head body 1. The shower head body 1 is provided with a water distribution mechanism 4 and a plurality of first water outlet holes 13, and the water distribution mechanism 4 is used to control a water delivery state of the first water outlet hole 13. A water partition disk 2 and a plurality of rotary mechanisms 3 are fixedly disposed in the shower head body 1. A plurality of pressurizing mechanisms 21 are disposed on the water partition disk 2, and the pressurizing mechanism 21 includes a plurality of water guide holes 211 annularly arranged. A flow guide surface 213 inclined toward the first water outlet hole 13 is disposed inside the water guide hole 211. The inclination direction of the flow guide surfaces 213 of each pressurizing mechanism 21 is co-directionally disposed in a circumferential direction. In this solution, the inclination directions of the flow guide surfaces 213 disposed co-directionally along the circumferential direction in a same pressurizing mechanism 21 are unified as clockwise or counterclockwise such that a vortex flow is formed when water flows through to provide a rotary power. The rotary mechanism 3 includes a rotor 31 and a drive gear 32 in transmission connection with the rotor 31. The rotor 31 is disposed below the pressuring mechanism 21 and in rotatable connection with the water partition disk 2. A rotary shaft 33 corresponding to the first water outlet hole 13 is disposed on the drive gear 32, and the rotary shaft 33 is rotatably mounted in the first water outlet hole 13 and axially provided with an outlet water passage 331 with both ends in communication. Specifically, the shower head body 1 includes an upper cover 11 and a lower cover 12 in mutual cooperation. The first water outlet hole 13 is disposed on the upper cover 11, the upper cover 11 and the lower cover 12 are fixed to form a mounting chamber, and the water partition disk 2 and the rotary mechanism 3 both are disposed in the mounting chamber.

In this embodiment, a pinion 34 is coaxially disposed on the rotor 31, where the pinion 34 has a number of teeth less than a number of teeth of the drive gear 32, and the pinion 34 is in engagement transmission with the drive gear 32. With the disposal of small and large gears, the rotor 31 slows down and increases its torque when transmitted to the drive gear 32, further increasing the rotary power of the drive gear 32. The rotor 31 and the pinion 34 are integrally formed, and the drive gear and the rotary shaft 32 are integrally formed.

Furthermore, the rotary mechanism 3 further includes a water partition piece 35 embedded in an end of the outlet water passage 331 away from the first water outlet hole 13. A plurality of small holes 351 are disposed uniformly on the water partition piece 35. In this way, water flows through the small holes 351 and then into the outlet water passage 331 to effectively avoid impact caused by an excessively large water flow to the wall of the rotary shaft and reduce wear. Further, it is avoided that the secondary vortex flows generated by rotation of the rotor 31 then form small vortexes in the rotary shaft to interfere with the rotation of the drive gear 32.

Furthermore, the outlet water passage 331 includes a flow guide portion 3311, a water outlet 3312 and a flow expanding portion 3313 sequentially connected. The water outlet 3312 has a cross sectional area smaller than a cross sectional area of the flow guide portion 3311, and the flow expanding portion 3313 is horn-shaped. In this case, when water flows out of the water outlet 3312 through the flow guide portion, a water pressure and a flow velocity are both increased due to change of cross sectional area. At the same time, under the guide of the horn-shaped flow expanding portion 3313, a denser jet water flow of a larger area will be formed. Preferably, the water outlet 3312 may be of rectangle, ellipse or other similar elongated shapes. In this case, when the rotary shaft 33 rotates, the jet water flow at the water outlet 3312 may act on human body to give a rotary pressure similar to massager, thus improving user experience.

Preferably, a corresponding arc-shaped side wall is formed along a central circumferential direction of the pressurizing mechanism 21 in the water guide hole 211 to further guide the water flow so as to form a small vortex flow in cooperation with the flow guide surface 213. At the same time, the water pressure is increased to increase the rotary power for the rotary mechanism 3 located below such that the rotary mechanism 3 is always driven sufficiently to ensure a constant and uniform rotation.

During use, water flows to the pressurizing mechanism 21 through a water inlet end of the shower head body 1 and generates a small vortex flow under the action of the water guide hole 211 and the flow guide surface 213, and further drives the rotor 31 to start rotating along a vortex flow direction. The rotor 31 drives the drive gear 32 and the rotary shaft 33 to rotate synchronously by use of the pinion 34. When water flows out of the outlet water passage 331, a rotary jet water flow will be formed.

In this embodiment, the water distribution mechanism 4 includes a water distribution disk 41 fixedly connected to a knob 42. The water distribution disk 41 is disposed in the mounting chamber of the shower head body 1, the knob 42 is rotatably connected to the upper cover 11, and the water distribution disk 41 and the knob 42 are fixedly connected through a round shaft. The water distribution disk 41 is disposed between the water partition disk 2 and the first water outlet hole 13. A first water inlet hole 411 is disposed on the water distribution disk 41, a plurality of mutually-independent first water passages 22 and second water passages 23 are disposed on the water partition disk 2, and the first water inlet hole 411 communicates with different first water outlet holes 13 respectively through the first water passages 22 and the second water passages 23.

Specifically, a first panel 5 and a second panel 6 are further disposed in the mounting chamber of the shower head body 1. The first panel 5 is disposed between the water distribution disk 41 and the water partition disk 2 and the second panel 6 is disposed at a side of the water partition disk 2 close to the first water outlet hole 13. The water partition disk 2 has an area less than the first panel 5 and the second panel 6. A plurality of second water inlet holes 51 in respective communication with the first water passage 22 and the second water passage 23 are disposed on the first panel 5, and partition walls corresponding to the first water passage 22 and the second water passage 23 are disposed on the first panel 5. When mounting is completed, the partition walls are attached to the side walls of the first water passage 22 and the second water passage 23 so as to form non-communicating water passages between the first panel 5 and the water partition disk 2. The first water passage 22 is a closed water passage disposed on the water partition disk 2 and the second water passage 23 is an open water passage disposed on the water partition disk 2.

In this embodiment, a vertical wall 61 corresponding to the water partition disk 2 and a second water outlet hole 62 in cooperation with the first water outlet hole 13 are disposed on the second panel 6. The vertical wall 61 and the water partition disk 2 cooperate to form an inlet water chamber for mounting the rotary mechanism 3, portions of the first panel 5 and the second panel 6 beyond the water partition disk 2 form a water-through chamber in the shower head body 1, and the inlet water chamber and the water-through chamber are mutually independent. That is, water flows out of the water partition disk 2 through the second water passage 23 and then into the water-through chamber. Specifically, the second water outlet hole 62 located inside the vertical wall 61 (i.e. inside the inlet water chamber) is in communication with the first water passage 22, the second water outlet hole 62 outside the vertical wall 61 is in communication with the second water passage 23, and the pressurizing mechanism 21 is disposed inside the first water passage 22.

During use, the water distribution disk 41 is rotated to enable the first water inlet hole 411 to be aligned with different second water inlet holes 51 to control water to flow out of at least one of the first water passage 22 and the second water passage 23. When water flows through the first water passage 22, rotary jet water is formed under the action of the pressurizing mechanisms 21 and the rotary mechanism 3 and subsequently discharged from the second water outlet holes 62 in the inlet water chamber. When water flows through the second water passage 23, the water is discharged from the second water outlet holes 62 in the water-through chamber.

In this solution, two or more water passages may be disposed simply by adjusting the number of water passages on the water partition disk 2 and opening corresponding water-through holes.

Preferably, the first water outlet holes 13 may be disposed to have several groups of different holes sizes to form more water delivery modes by combination.

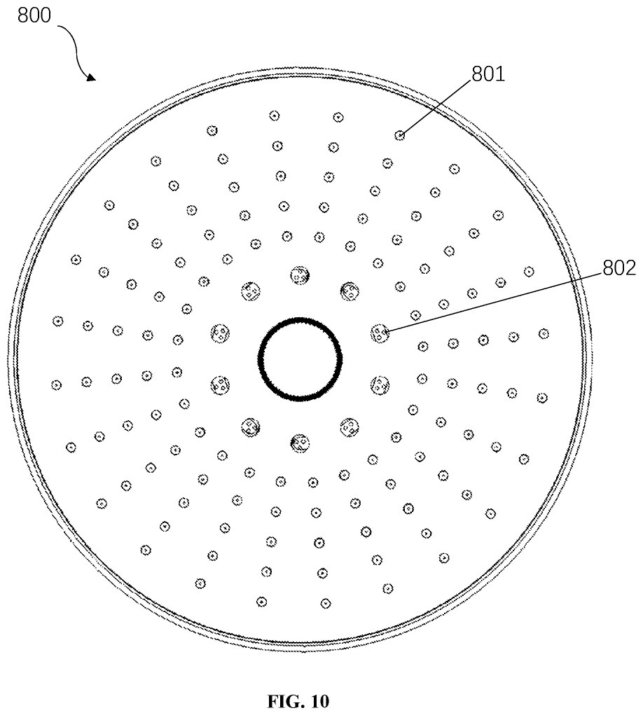

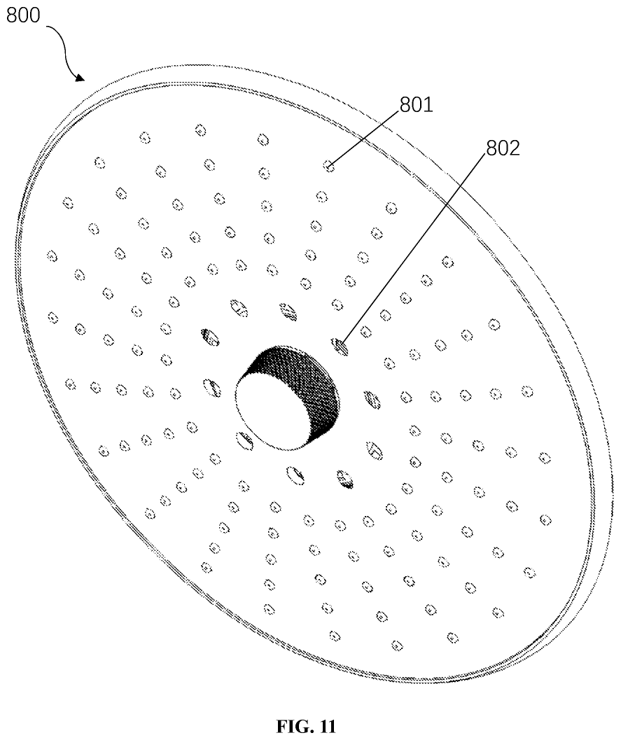

As shown in FIGS. 10-11, a second embodiment of the present disclosure may include several water outlet holes in a different configuration as described above. In particular, second shower head 800 includes third water outlet holes 801 arranged in equally spaced rings of increasing diameter from the center of second shower head 800 to the outer rim of second shower head 800. Additionally, second shower head 800 includes fourth water outlet holes 802 arranged in an ring adjacent to the center of second shower head 800. Second water inlet hole 803 is configured to be connected to a water source, and distributes water throughout second shower head 800 before being output via the water outlet holes.

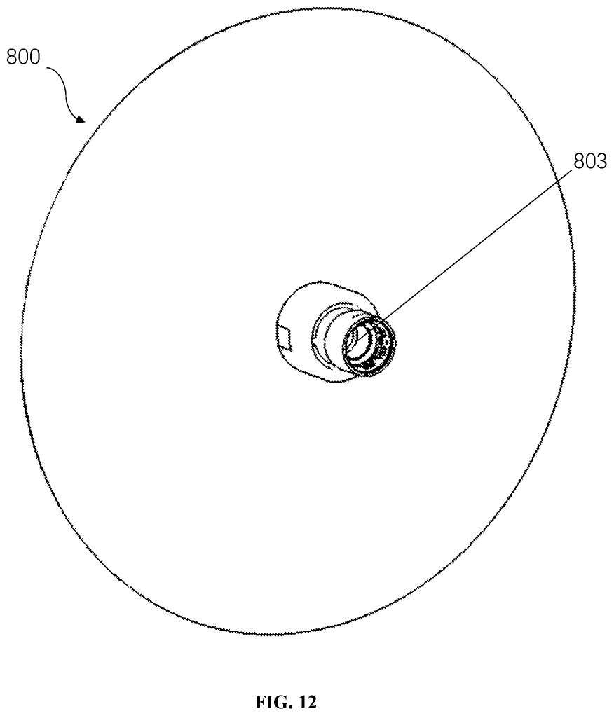

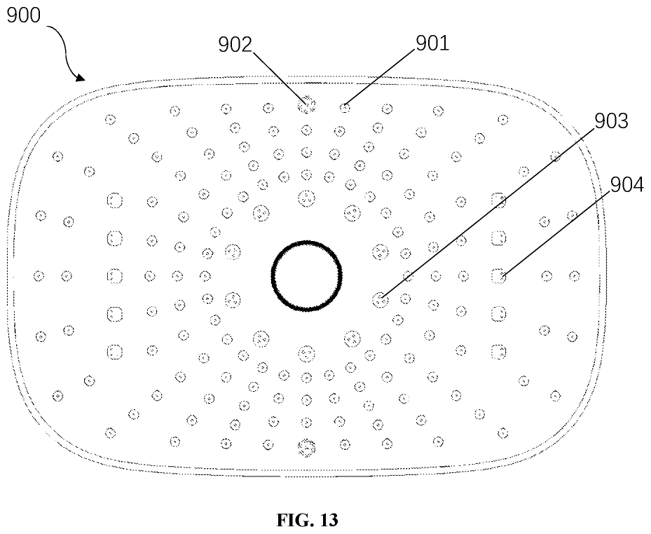

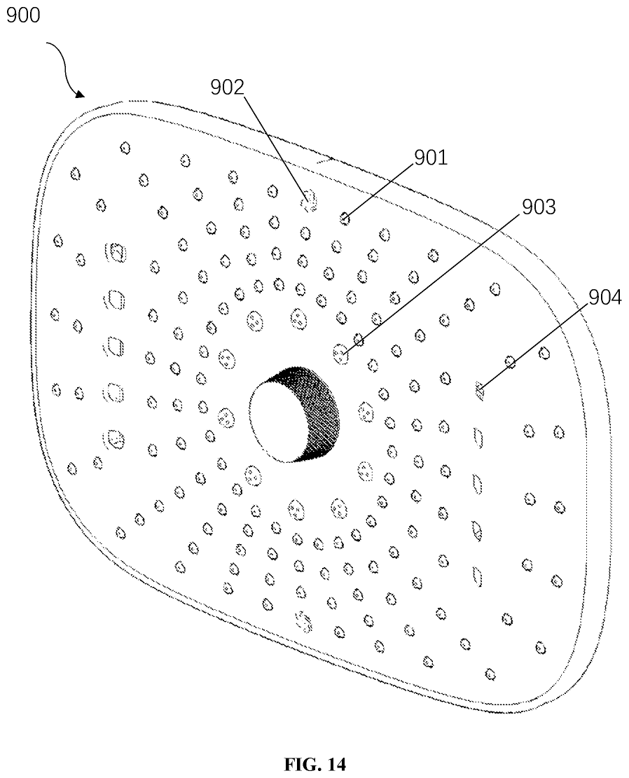

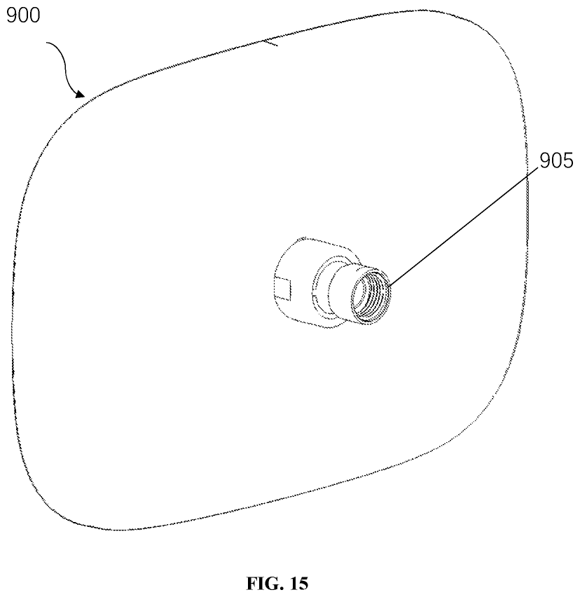

As shown in FIGS. 12-13, a third embodiment of the present disclosure may include third shower head 900 having a rounded, rectangular body and several different water outlet holes. The water outlet holes of third shower head 900 include fifth water outlet holes 901, sixth water outlet holes 902, seventh water outlet holes 903, and eighth water outlet holes 904. Each of the water outlet holes are arranged on the surface of third shower head 900 to enable third shower head 900 to output several different flow types. Third water inlet hole 905 is configured to be connected to a water source, and distributes water throughout second shower head 900 before being output via the water outlet holes.

As will be appreciated by one skilled in the art, the different embodiments of the present disclosure are not intended to limit the invention as claimed, and are mere exemplary configurations of the invention, where the various components of each embodiment may be interchanged.

The above descriptions are merely preferred embodiments of the present disclosure and are not used to limit the present disclosure. For those skilled in the art, there may be various changes or modifications to the present disclosure. Any changes, equivalent substitutions and improvements and the like made within the spirit and principle of the present disclosure shall all fall within the scope of protection of the present disclosure.

What is claimed is:

1. A shower head with rotary jet water, comprising a shower head body (1), wherein the shower head body (1) is provided with a water distribution mechanism (4) and a plurality of first water outlet holes (13), and the water distribution mechanism (4) is used to control a water delivery state of the first water outlet hole;
a water partition disk (2) and a plurality of rotary mechanisms (3) are fixedly disposed in the shower head body (1), a plurality of pressurizing mechanisms (21) are disposed on the water partition disk (2), the pressurizing mechanism (21) comprises a plurality of water guide holes (211) annularly arranged, a flow guide surface (213) inclined toward the first water outlet hole (13) is disposed inside the water guide hole (211), and the inclination direction of the flow guide surfaces (213) of each pressurizing mechanism (21) is co-directionally disposed in a circumferential direction;
the rotary mechanism (3) comprises a rotor (31) and a drive gear (32) in transmission connection with the rotor (31), the rotor is disposed below the pressuring mechanism (21), a rotary shaft (33) corresponding to the first water outlet hole (13) is disposed on the drive gear (32), and the rotary shaft (33) is rotatably mounted in the first water outlet hole (13) and axially provided with an outlet water passage (331) with two ends in communication.

2. The shower head of claim 1, wherein a pinion (34) is coaxially disposed on the rotor (31) and the pinion (34) is in engagement transmission with the drive gear (32).

3. The shower head of claim 1, wherein the rotary mechanism (3) further comprises a water partition piece (35) embedded in an end of the outlet water passage (331) away from the first water outlet hole (13), and a plurality of small holes (351) are uniformly disposed on the water partition piece (35).

4. The shower head of claim 1, wherein the outlet water passage (331) comprises a flow guide portion (3311), a water outlet (3312) and a flow expanding portion (3313) sequentially connected, the water outlet (3312) has a cross sectional area smaller than a cross sectional area of the flow guide portion (3311), and the flow expanding portion (3313) is horn-shaped.

5. The shower head of claim 1, wherein the water distribution mechanism (4) comprises a water distribution disk (41) and a knob (42) fixedly connected, the knob (42) is rotatably connected at an outer side of the shower head body (1), the water distribution disk (41) is disposed between the water partition disk (2) and the first water outlet hole (13), a first water inlet hole (411) is disposed on the water distribution disk (41), a plurality of mutually-independent first water passages (22) and second water passages (23) are disposed on the water partition disk (2), and the first water inlet hole (411) communicates with different first water outlet holes (13) respectively through the first water passages (22) and the second water passages (23).

6. The shower head of claim 5, wherein a first panel (5) is disposed in the shower head body (1), the first panel (5) is disposed between the water distribution disk (41) and the water partition disk (2), a plurality of second water inlet holes (51) in respective communication with the first water passages (22) and the second water passages (23) are disposed on the first panel (5), and when the first water inlet hole (411) is in communication with the second water inlet hole (51), the corresponding first water passage (22) or second water passage (23) is opened.

7. The shower head of claim 6, wherein a second panel (6) is disposed in the shower head body (1), the second panel (6) is disposed at a side of the water partition disk (2) close to the first water outlet hole (13), a vertical wall (61) corresponding to the water partition disk (2) and a second water outlet hole (62) corresponding to the first water outlet hole (13) are disposed on the second panel (6), the vertical wall (61) and the water partition disk (2) cooperate to form an inlet water chamber for mounting the rotary mechanism (3), the second water outlet hole (62) located inside the vertical wall (61) is in communication with the first water passage (22), the second water outlet hole (62) outside the vertical wall (61) is in communication with the second water passage (23), and the pressurizing mechanism (21) is disposed inside the first water passage (22).

8. The shower head of claim 1, wherein the first water outlet holes (13) are disposed to have several groups of different hole sizes.
